(19) United States
(12) Patent Application Publication
(10) Pub. No.: US 2002/0096494 A1
(43) Pub. Date: Jul. 25, 2002

(54) Post-cleaning method of a via etching process

(75) Inventors: Hungyueh Lu, Hsinchu (TW); Hong-Long Chang, Hsinchu (TW); Fang-Fei Liu, Hsinchu Hsien (TW)

Correspondence Address: DARBY & DARBY P.C., 805 Third Avenue, New York, NY, 10022, US

(73) Assignee: ProMOS Technologies Inc.

(21) Appl. No.: 09/768,523

(22) Filed: Jan. 24, 2001

(51) Int. Cl. B44C 1/22; C23F 1/00

(52) U.S. Cl. 216/57

(57) ABSTRACT

A post-cleaning method of a via etching process in the present invention has the steps of: (a) performing a photoresist strip process to remove the photoresist layer; b) performing a dry cleaning process which uses CF₄ as the main reactive gas and is operated by dual powers; and (c) performing a water-rinsing process.

### BACKGROUND OF THE INVENTION

1. Field of the Invention

The present invention relates in general to a cleaning method, in particular, the present invention relates to a post-cleaning method of a via etching process.

2. Description of the Related Art

In the semiconductor processing for pursuing the goal of minute line width and high integration, the product yield is greatly concerned with particles. In particular, during a via etching process, the residues remaining in the via will deteriorate the electrical-connecting property between metal layers.

Please refer to FIG. 1 and FIG. 2. FIG. 1 is a cross-sectional schematic diagram of a via according to the prior art. FIG. 2 is a flow chart of a post-cleaning method of a via etching process according to the prior art. A wafer 10 comprises a substrate 12, a metal layer 14 formed on the substrate 12, an oxide layer 16 covered on the metal layer 14, and a photoresist layer 18 coated on the oxide layer 16. By using a dry etching process, a via 20 is patterned to pass through the photoresist layer 18 and the oxide layer 16 till exposing a predetermined area of the metal layer 14. In a post-cleaning method of the via etching process, the step 22 of a photoresist strip process is firstly performed to remove the photoresist layer 18 by a dry etching process in a plasma reactor, wherein the hydrocarbon inside the photoresist layer 18 is reacted with oxygen plasma to be stripped off and the produced gases, such as CO, CO₂ and H₂O are pumped by a vacuum system. However, the photoresist strip process also produces polymer residues and which greatly remain in the via 20. For this reason, the step 24 of a wet cleaning process is performed for cleaning off the polymer residues. In general, the wafer 10 is dipped into sink filled with a specific etching solution, such as ACT, EKC or other alkaline compounds, on an appropriate condition of dipping time, temperature and solution concentration so as to make the polymer residues react with the etching solution to be removed off. Finally, at the step 26 of a water-rinsing process, the wafer 10 is turned vertically to ensure the fringe of the wafer 10 being cleaned off, and then the wafer 10 is dipped into deionized water to clean off the remaining etching solution.

Nevertheless, the wet cleaning method that utilizes the chemicals such as ACT and EKC with high waste volume encounters problems in an increasing price of the chemicals and a shortage of the chemical resource. It does not conform to expectations for the cost considerations of mass production. Also, since dipping the wafer 10 into the etching solution consumes a period of time to make the polymer residues completely react with the etching solution, the overall via etching process period is increased.

### SUMMARY OF THE INVENTION

Therefore, the present invention provides a post-cleaning method of a via etching process, which substitutes a dry cleaning process for the wet cleaning process to solve the above-mentioned problems.

The post-cleaning method of a via etching process in the present invention includes : (a) performing a photoresist strip process to remove the photoresist layer; b) performing a dry cleaning process which uses CF₄ as the main reactive gas and is operated by dual powers; and (c) performing a water-rinsing process.

It is an advantage of the present invention that since the dry cleaning process substitutes the wet cleaning process to remove the polymer residues without using costly and rare alkaline compounds, the production cost is substantially decreased. Also, the dry cleaning process can quickly remove the polymer residues and the wafer needs not to be turned vertically before dipping into deionized water, so the overall post-clean process becomes more efficient. Furthermore, the photoresist strip process and the dry cleaning process can be in-situ performed; therefore this will facilitate the post-clean process.

This and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

The present invention can be more fully understood by reading the subsequent detailed description in conjunction with the examples and references made to the accompanying drawings, wherein:

FIG. 1 is a cross-sectional schematic diagram of a via according to the prior art.

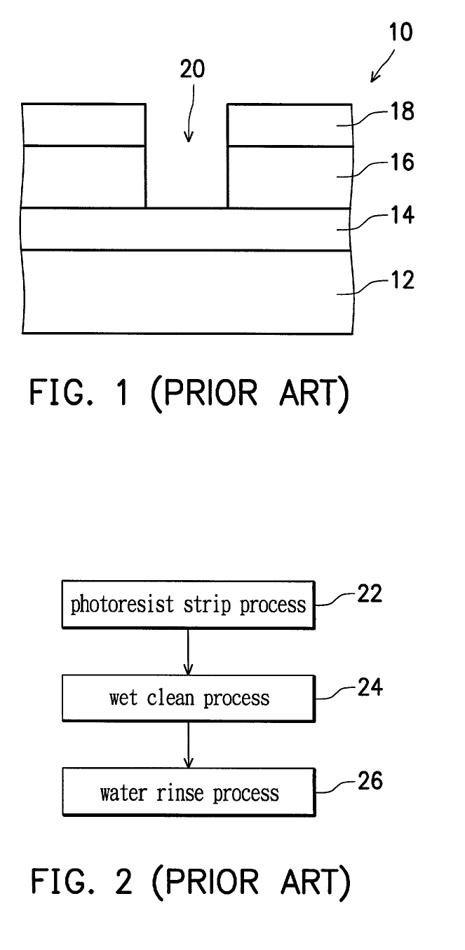

FIG. 2 is a flow chart of a post-cleaning method of a via etching process according to the prior art.

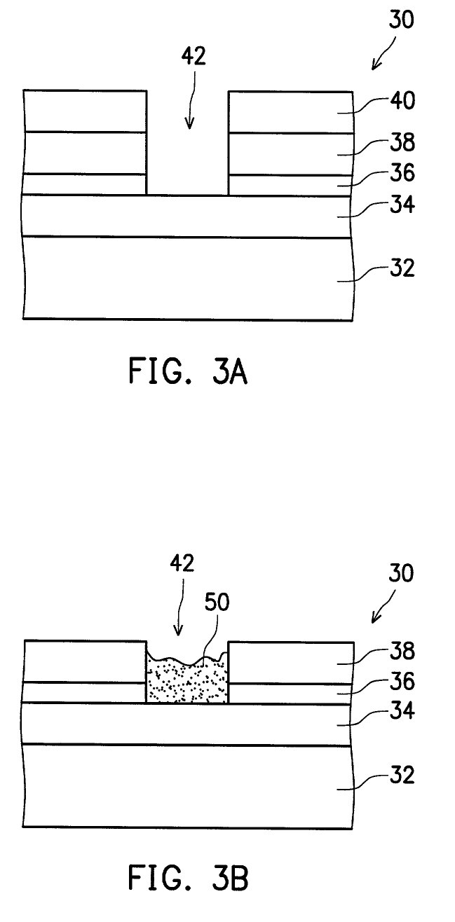

FIGS. 3A to 3D are cross-sectional schematic diagrams of a cleaning method of a via etching process according to the first embodiment of the present invention.

FIG. 4 is a flow chart of a post-cleaning method of the via etching process according to the present invention.

FIGS. 5A to 5C, which show cross-sectional schematic diagrams of another post-cleaning method of the via etching process according to the second embodiment of the present invention.

### DETAILED DESCRIPTION OF THE PREFERRED EMBODIMENT

[First Embodiment]

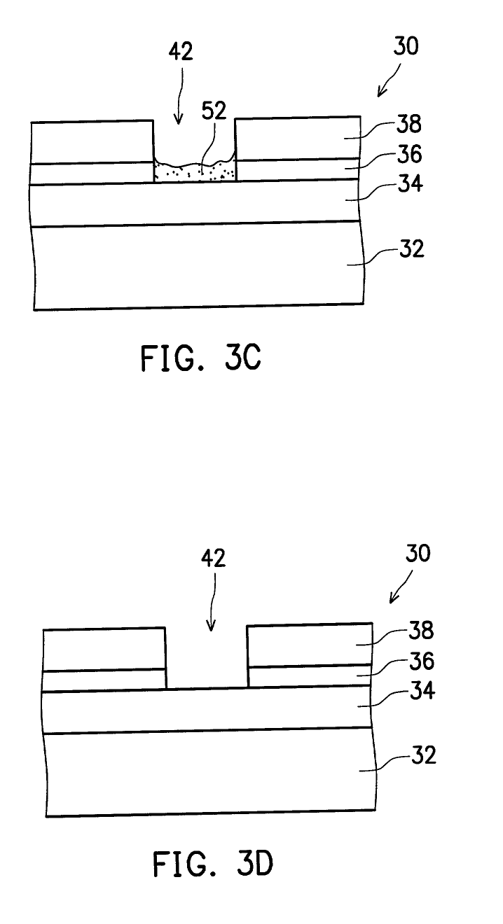

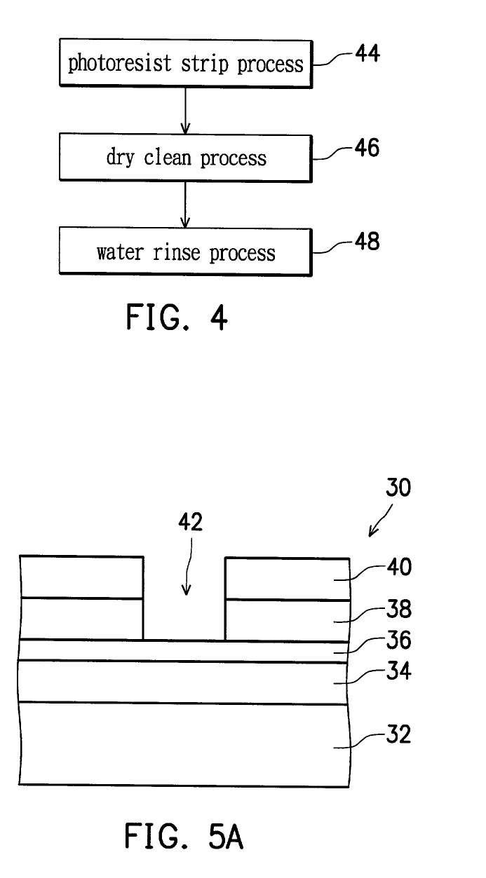

Please refer to FIG. 3 and FIG. 4. FIGS. 3A to 3D are cross-sectional schematic diagrams of a cleaning method of a via etching process according to the first embodiment of the present invention. FIG. 4 is a flow chart of a post-cleaning method of the via etching process according to the present invention. As shown in FIG. 3A, a wafer 30 comprises a substrate 32, an aluminum (Al) layer 34 formed on the substrate 32, a titanium nitride (TiN) layer 36 formed on the Al layer 34, an oxide layer 38 covered on the TiN layer 36, a photoresist layer 40 coated on the oxide layer 38, and a via 42. The oxide layer 38 is preferably made of TEOS-oxide. The via 42 is preferably fabricated by a dry etching process to pass through the photoresist layer 40, the oxide layer 38 and the TiN layer 36 till exposing a predetermined area of the Al layer 34 that is used as an etch stop layer.

As shown in FIG. 4, in the post-cleaning method of the present invention, the step 44 of a photoresist strip process is firstly performed to remove the photoresist layer 40 by a dry etching process in a plasma reactor, wherein the hydrocarbon inside the photoresist layer 40 is reacted with oxygen plasma to be stripped off, the produced gases, such as CO, CO₂ and H₂O are pumped by a vacuum system, and the produced polymer residues 50 remain in the via 42, as shown in FIG.3B. Then, the step 46 of a dry cleaning process is performed to remove the polymer residues 50 by a dry etching process, wherein the operation conditions are 15˜25 seconds, 60° C.˜80° C., 500 Mt, 700 W˜900 W of -wave power, 80 W˜120 W of RF power. As to the key point, it is preferred to use CF₄ as the main reactive gas combined with minor reactive gases, such as N₂ and H₂ wherein the proportion of CF₄ to the overall reactive gases is between ½ and ⅙. Besides, it is also preferred to use CF₄ and O₂ as the main reactive gases, wherein the flow rate of CF₄ is about 30 sccm and the flow rate of O₂ is about 500 sccm. Therefore, at the same time the polymer residues 50 are removed, CF₄ can react with TiN to form water-solutable TiFₓ residues 52 and NF₃ gas, CF₄ also can react with the oxide layer 38 to form SiF₄, SiFₓ, CO and CO₂ and CF₄ even can react with Al to form water-solutable AlFₓ residues, as shown in FIG. 3C. Although those gases are pumped by a vacuum system, the water-solutable residues 52 still remain in the via 42. Finally, at the step 48 of a water-rinsing process, the wafer 30 is directly dipped into deionized water to make the water-solutable residues 52 immediately dissolve in deionized water, and thereby all residues remaining in the via 42 are cleaned off, as shown in FIG. 3D.

Compared with the prior post-cleaning method, in the post-cleaning method of the via etching process according to the present invention, the dry cleaning process substitutes the wet cleaning process to remove the polymer residues 50 without using costly and rare alkaline compounds, such as ACT and EKC. Hence, the production cost is substantially decreased. Also, the dry cleaning process can quickly remove the polymer residues 50 and the wafer 30 does not need to be turned vertically before dipping into deionized water, so the overall post-clean process becomes more efficient. Furthermore, the photoresist strip process and the dry cleaning process can be in-situ performed to remove the photoresist layer 40 and the polymer residues 50 in sequence by adjusting the operation factors of the plasma reactor to an appropriate condition. This will facilitate the post-clean process.

[Second Embodiment]

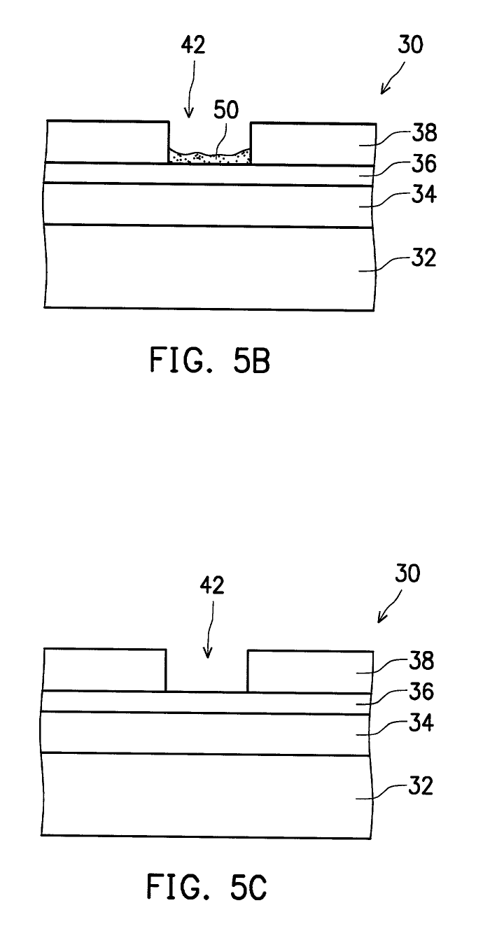

The above-mentioned post-cleaning method is applied to the case that employs the Al layer 34 as the etch stop layer. The present invention provides another cleaning method in the case that employs the TiN layer 36 as the etch stop layer. Please refer to Figs. 5A to 5C, which show cross-sectional schematic diagrams of another post-cleaning method of the via etching process according to the second embodiment of the present invention. As shown in FIG. 5A, by using the TiN layer 36 as the etch stop layer, the via 42 passes through the photoresist layer 40 and the oxide layer 38 till exposing a predetermined area of the TiN layer 36. In accordance with the steps 44˜46, the polymer residues 50 can be removed. Compared with the first embodiment, since the polymer residues 50 are less produced during the photoresist strip process, as shown in FIG. 5B, the dry cleaning process only employs O₂ with a flow rate about 1000 sccm as the main reactive gas and the operation conditions that are similar to the first embodiment, and finally the polymer residues 50 are cleaned off, as shown in FIG. 5C.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A post-cleaning method of a via etching process for cleaning a wafer, the wafer comprising an aluminum (Al) layer, a titanium nitride (TiN) layer covered on the aluminum layer, an oxide layer covered on the TiN layer, a photoresist layer patterned on the oxide layer, and a via passing through the photoresist layer, the oxide layer and the TiN layer till exposing a predetermined area of the Al layer, the cleaning method comprising the steps of:
(a) performing a photoresist strip process to remove the photoresist layer;
(b) performing a dry cleaning process which uses CF₄ as the main reactive gas and is operated by dual powers; and
(c) performing a water-rinsing process.

2. The post-post-cleaning method as claimed in claim 1, wherein the proportion of CF₄ to the overall reactive gases is between ½ and ⅙.

3. The post-cleaning method as claimed in claim 1, wherein the dry cleaning process further uses O₂ as the main reactive gas.

4. The post-cleaning method as claimed in claim 1, wherein the dual powers comprises RF power and -wave power.

5. The post-cleaning method as claimed in claim 4, wherein the RF power is between 80 W and 120 W.

6. The post-cleaning method as claimed in claim 4, wherein the -wave power is between 700 W and 900 W.

7. The post-cleaning method as claimed in claim 1, wherein the water-rinsing process dips the wafer into deionized water.

8. The post-cleaning method as claimed in claim 1, wherein the oxide layer is made of a TEOS-oxide.

9. The post-cleaning method as claimed in claim 1, wherein the photoresist strip process is a dry etching process.

10. The post-cleaning method as claimed in claim 1, wherein the photoresist strip process and the dry cleaning process are in-situ.

11. A post-cleaning method of a via etching process for cleaning a wafer, the wafer comprising a titanium nitride (TiN) layer, an oxide layer covered on the TiN layer, a photoresist layer patterned on the oxide layer, and a via passing through the photoresist layer and the oxide layer till exposing a predetermined area of the TiN layer, the cleaning method comprising the steps of:
(a) performing a photoresist strip process to remove the photoresist layer;
(b) performing a dry cleaning process which uses O₂ as the main reactive gas and is operated by dual powers; and
(c) performing a water-rinsing process.

12. The post-cleaning method as claimed in claim 11, wherein the dual powers comprises RF power and -wave power.

13. The post-cleaning method as claimed in claim 12, wherein the RF power is between 80 W and 120 W.

14. The post-cleaning method as claimed in claim 12, wherein the -wave power is between 700 W and 900 W.

15. The post-cleaning method as claimed in claim 11, wherein the water-rinsing process dips the wafer into deionized water.

16. The post-cleaning method as claimed in claim 11, wherein the oxide layer is made of a TEOS-oxide.

17. The post-cleaning method as claimed in claim 11, wherein the photoresist strip process is a dry etching process.

18. The post-cleaning method as claimed in claim 11, wherein the photoresist strip process and the dry cleaning process are in-situ.
